(19) United States
(12) Patent Application Publication
(10) Pub. No.: US 2026/0094363 A1
(43) Pub. Date: Apr. 2, 2026

(54) NOT-SO-OPTIMAL TRANSPORT FLOWS FOR THREE-DIMENSIONAL POINT CLOUD GENERATION

(71) Applicant: NVIDIA Corporation, Santa Clara, CA (US)

(72) Inventors: Arash Vahdat, San Mateo, CA (US); Ka Hei Hui, Tuen Mun (HK); Chao Liu, Santa Clara, CA (US); Xiaohui Zeng, Toronto (CA)

(21) Appl. No.: 19/072,518

(22) Filed: Mar. 6, 2025

Related U.S. Application Data
(60) Provisional application No. 63/700,253, filed on Sep. 27, 2024.

(51) Int. Cl. G06T 17/00; G06T 5/73

(52) U.S. Cl. CPC G06T 17/00; G06T 5/73; G06T 2207/20081; G06T 2207/20084

(57) ABSTRACT

Systems and methods are disclosed that perform training of a flow-based generative model for three-dimensional (3D) point cloud generation. For example, the method may include obtaining offline optimal transport (OT) maps for a training set comprising 3D point clouds. The method further includes randomly sampling from the training set to obtain data samples indicating points from 3D point clouds and determining corresponding noise samples associated with the data samples based on the offline OT maps. The method also includes obtaining modified noise samples based on adding noise to perturb the corresponding noise samples and training the flow-based generative model based on the modified noise samples and the data samples.

### CLAIM OF PRIORITY

This application claims the benefit of U.S. Provisional Application No. 63/700,253 titled “Approximately Optimal Transport Flows for 3D Point Cloud Generation,” filed Sep. 27, 2024, the entire contents of which is incorporated herein by reference.

### BACKGROUND

Generating three-dimensional (3D) point clouds is one of the fundamental problems in 3D modeling with applications in shape generation, 3D reconstruction, 3D design, and perception for robotics and autonomous systems. Recently, diffusion models and flow matching have become the de-facto frameworks for learning generative models for 3D point clouds. These frameworks often overlook 3D point cloud permutation invariance, implying the rearrangement of points does not change the shape that they represent.

However, in closely related areas, equivariant optimal transport (OT) flows have been recently developed for 3D molecules that may be considered as sets of 3D atom coordinates. These frameworks learn permutation invariant generative models (e.g., all permutations of the set have the same likelihood under the learned generative distribution) and the frameworks are trained using optimal transport between data and noise samples, which yield several key advantages including low sampling trajectory curvatures, low-variance training objectives, and fast sample generation. However, upon examination, it was noticed that these techniques for 3D point cloud generation scale poorly for point cloud generation. This may be mainly due to the fact that point clouds in practice include thousands of points whereas molecules are assumed to have tens of atoms in previous studies. Solving the sample-level OT mapping between a batch of training point clouds and noise samples is computationally expensive. Conversely, ignoring permutation invariance when solving batch-level OT fails to produce high-quality OT due to the excessive possible permutations of point clouds. Accordingly, there is a need for addressing these issues and/or other issues associated with the prior art.

### SUMMARY

Embodiments of the present disclosure relate to “Not-So-Optimal” (NOS) transport flows for 3D point cloud generation. For example, systems and methods are disclosed that utilize the NOS transport flow matching for training a neural network such as a flow-based generative model that utilizes normalizing flow. For instance, learning generative models of 3D point clouds is one of the fundamental problems in 3D generative learning with applications in shape generation, 3D reconstruction, 3D design, and perception for robotics and autonomous systems. One of the key properties of point clouds is their permutation invariance (e.g., changing the order of points in a point cloud does not change the shape they represent). Recently, diffusion models and flow matching have become the de-facto frameworks for learning generative models for 3D point clouds. However, these frameworks often overlook 3D point cloud permutation invariance.

As such, embodiments of the present disclosure describe a simple and scalable generative model for 3D point cloud generation using flow matching (e.g., NOS transport flow matching). For example, embodiments of the present disclosure may first utilize an efficient method to obtain an approximate optimal transport (OT) between point cloud and noise samples. Instead of searching for an optimal permutation between the point cloud and noise samples online during training, which is computationally expensive, embodiments of the present disclosure precompute OTs between a dense point superset and a dense noise superset offline. Since subsampling a superset preserves the underlying shape, embodiments of the present disclosure subsample the point superset and obtain corresponding noise from the precomputed OT to construct a batch of noise-data pairs for training the flow models.

In some examples, embodiments of the present disclosure utilize a NOS transport flow matching process to perform offline pre-computation to generate offline OT maps that are used during online training of the generative flow-based model. Additionally, and/or alternatively, the NOS transport flow matching process may further include randomly subsampling from only the training set of the 3D point clouds, and obtaining the training data pairs of the noise samples and data samples based on the random subsampling the offline OT maps. Additionally, and/or alternatively, the NOS transport flow matching process may also use a hybrid coupling that includes adding a slight perturbation of noise to the noise samples obtained by the offline OT maps and using the modified noise samples for training of the generative flow-based model.

In an embodiment, a computer-implemented method for training a flow-based generative model for 3D point cloud generation is provided. The method comprises obtaining offline OT maps for a training set comprising a plurality of 3D point clouds. Each of the offline OT maps is associated with a 3D point cloud from the training set and indicates a plurality of entries and each of the plurality of entries indicates a point from the associated 3D point cloud and a corresponding noise sample. The method further includes randomly sampling from the training set to obtain a plurality of data samples indicating points from one or more 3D point clouds from the plurality of 3D point clouds and determining a plurality of corresponding noise samples associated with the plurality of data samples based on the offline OT maps. The method also includes obtaining a plurality of modified noise samples based on adding noise to perturb the plurality of corresponding noise samples and training the flow-based generative model based on the plurality of modified noise samples and the plurality of data samples.

### BRIEF DESCRIPTION OF THE DRAWINGS

The present systems and methods for NOS transport flows for 3D point cloud generation are described in detail below with reference to the attached drawing figures, wherein:

FIG. 1A illustrates graphical representations of utilizing different approaches to morph a noise distribution to a data distribution, in accordance with an embodiment.

FIG. 1B shows a NOS transport flow matching process, in accordance with an embodiment.

FIGS. 2A and 2B show examples of point clouds that are generated using different approaches.

FIG. 3 provides a flow diagram illustrating a method for training a flow-based generative model for 3D point cloud generation, in accordance with an embodiment.

FIG. 4 is a conceptual diagram of a processing system implemented using a PPU, suitable for use in implementing some embodiments of the present disclosure.

FIG. 5A illustrates an exemplary system in which the various architecture and/or functionality of the various previous embodiments may be implemented.

FIG. 5B illustrates components of an exemplary system that can be used to train and utilize machine learning, in at least one embodiment.

FIG. 6 illustrates an exemplary streaming system suitable for use in implementing some embodiments of the present disclosure.

### DETAILED DESCRIPTION

Systems and methods are disclosed herein that relate to NOS transport flows for 3D point cloud generation, and in particular, to the training and using of a flow-based generative model for 3D point cloud generation. For instance, learning generative models of 3D point clouds is one of the fundamental problems in 3D generative learning. One of the key properties of point clouds is their permutation invariance. Recently, equivariant OT flows that learn permutation invariant generative models for point-based molecular data have been proposed, but these models scale poorly on large point clouds. In addition, learning OT flows (e.g., equivariant OT flows) is generally challenging since straightening flow trajectories make the learned flow model complex at the beginning of the trajectory. To remedy this, embodiments of the present disclosure utilize NOS transport flow models that obtain an approximate OT by an offline OT precomputation, which enables an efficient construction of OT pairs for training. During training, a hybrid coupling may be constructed by combining the approximate OT and independent coupling to make the target flow models easier to learn. In an extensive empirical study, it was demonstrated that the model described by one or more embodiments of the present disclosure outperforms conventional diffusion-based and flow-based approaches on a wide range of unconditional generation and shape completion using a benchmark.

As will be described in further detail below, embodiments of the present disclosure describe a simple and scalable generative model for 3D point cloud generation using flow matching (e.g., NOS transport flow matching). First, an efficient way to obtain an approximate OT between point cloud and noise samples is utilized. For instance, instead of searching for an optimal permutation between point cloud and noise samples online during training, which is computationally expensive, embodiments of the present disclosure precompute an OT between a dense point superset and a dense noise superset offline. Since subsampling a superset preserves the underlying shape, embodiments of the present disclosure simply subsample the point superset and obtain corresponding noise from the precomputed OT to construct a batch of noise-data pairs for training the flow models.

Based on utilizing embodiments of the present disclosure, it was demonstrated that the approximate OT reduces the pairwise distance between data and noise significantly and benefits from the advantages of OT flows, e.g., straightness of trajectories and fast sampling. However, it was shown that learning (equivariant) OT flows is generally challenging since straightening flow trajectories makes the learned flows complex at the beginning of the trajectory. Intuitively, in the OT coupling, the flow model should be able to switch between different target point clouds (e.g., different modes in the data distribution) with small variations in their input, making the flow model have high Lipchitz.

To remedy this, embodiments of the present disclosure utilize a simple approach to construct a less “optimal” hybrid coupling by blending the approximate OT and independent coupling used in the flow matching model. In particular, embodiments of the present disclosure may perturb the noise samples obtained from the approximate OT with small Gaussian noise. While this remedy makes the mapping less optimal from the OT perspective, it was empirically shown to have two main advantages. First, the target flow model is less complex and the generated points clouds have high sample quality. Second, when reducing the number of inference steps, the generation quality still degrades slower than other competing techniques, indicating smoother trajectories.

In summary, it was shown that existing OT approximations either scale poorly or produce low-quality OT for real-world point cloud generation. Furthermore, it was shown that equivariant OT flows have to learn a complex function with high Lipchitz at the beginning of the generation process. To tackle these issues, embodiments of the present disclosure utilize a NOS flow matching approach that involves an offline superset OT precomputation and online random subsampling to obtain an approximate OT, and adds a small perturbation to the obtained noise during training. An empirical comparison between NOS transport flows for 3D point cloud generation against diffusion models, flows, and OT flows on unconditional point cloud generation and shape completion on a benchmark was performed. Based on the comparison, it was shown that the model from embodiments of the present disclosure outperforms these frameworks for different sampling budgets over various competing baselines on the unconditional generative task. In addition, it was shown that embodiments of the present disclosure obtain reasonable generation quality on the shape completion task in less than five steps, which is challenging for other conventional approaches.

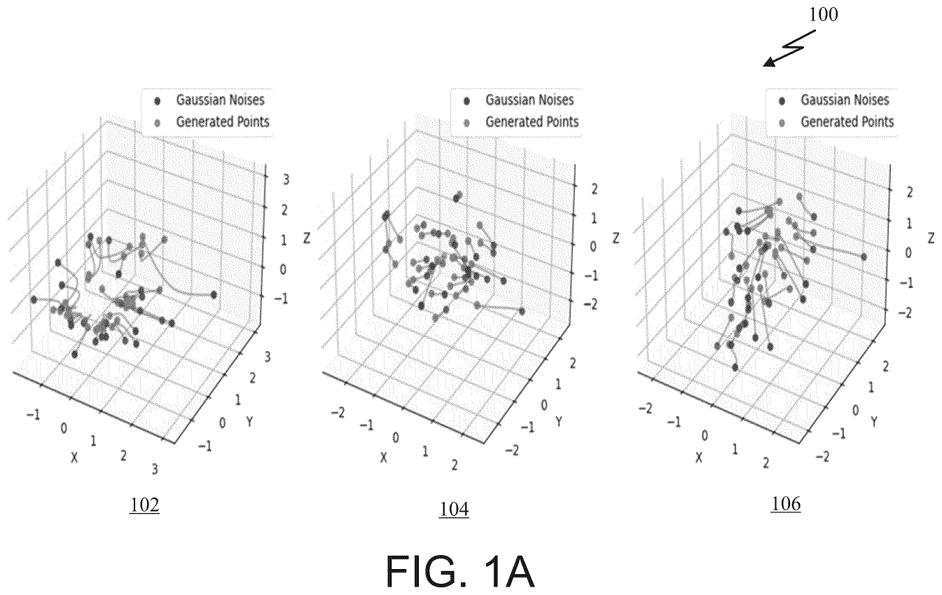

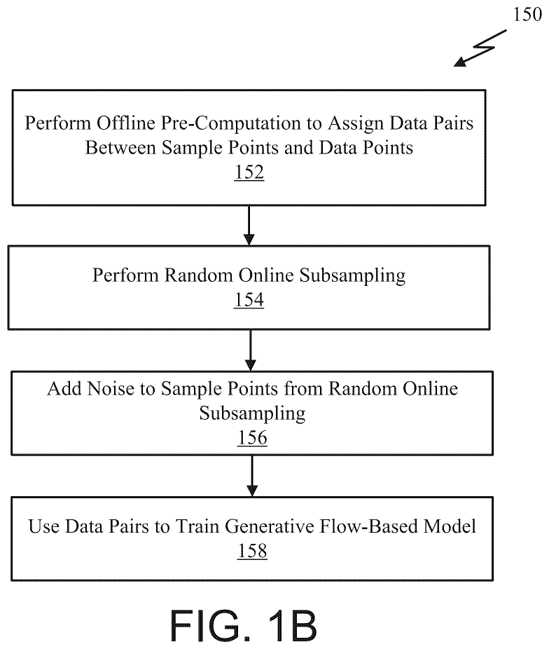

Before describing the NOS transport flow matching, a few preliminary aspects are discussed. For example, flow-based generative models may be learned (e.g., trained) to morph a noise distribution (e.g., a base Gaussian distribution) into a data distribution. This is shown below in FIG. 1A. FIG. 1A illustrates graphical representations 102-106 of utilizing different approaches to morph a noise distribution to a data distribution, in accordance with an embodiment.

For example, initially, noise samples may be obtained based on sampling from a noise distribution such as a Gaussian noise distribution and data samples may be obtained based on sampling from a training dataset (e.g., an image dataset and/or a 3D point cloud dataset). Subsequently, a flow-based generative model (e.g., a neural network that utilizes normalizing flow) may be trained to morph the noise samples to the data samples. For instance, each noise sample may be assigned to a data sample such that training data pairs are obtained that include one noise sample and one data sample. Afterwards, the flow-based generative model may be trained to learn the trajectories for each training data pair, which may indicate a path of movement for a noise sample to reach a data sample over a time period (e.g., from time t=0 to time t=1). The noise samples (i.e., “Gaussian Noises”), the data samples (i.e., the “Generated Points”), and the trajectories between them are shown in FIG. 1A.

In other words, the flow-based generative model is trained to utilize a time-variant vector field (e.g., a vector field associated with a period of time from time t=0 to time t=1) to morph each of the samples from the noise distribution (e.g., noise samples) into the samples obtained from the training dataset (e.g., data samples). For example, the time-variant vector field may continuously provide a vector over the period of time t=0 to t=1 indicating a direction and magnitude of movement of the noise samples in the direction of the data samples until reaching the data sample point.

Referring to FIG. 1A, each of the graphical representations 102-106 may use a different methodology to assign the training data pairs. For example, starting with the first graphical representation 102, which may be an independent coupling approach, the training data pairs may be assigned randomly. In independent coupling q(x₀, x₁)==q₁(x₁)q₀(x₀), the data and noise samples may be drawn from independent distributions. After obtaining the noise samples and data samples, each of the noise samples is randomly assigned to one of the data samples to obtain the training data pairs. Then, the flow-based generative model is trained to learn the time-variant vector field that morphs the noise samples to the corresponding data samples. However, as shown in the first graphical representation 102, the time-variant vector field may cause the trajectories from the noise samples to the data samples to be curved. Specifically, by performing independent coupling and randomly pairing the noise samples with the data samples, this causes the trajectory between a training data pair to curve, which is not ideal as it requires smaller time steps (e.g., due to the curve) and thus causes the ordinary differential equation (ODE) associated with the flow-based generative model to be more difficult to solve (e.g., requiring a greater compute time).

Therefore, instead of random assignment, conventional flow matching was utilized to avoid the computationally expensive simulation process caused by independent coupling. In conventional flow matching, the noise samples and the data samples are paired based on utilizing a conventional condition flow matching (CFM) objective, which is shown below:

$${L}_{CFM} = {𝔼}_{t , q ( {x}_{0} , {x}_{1} )} {‖ {v}_{θ , t} ( {x}_{t} ) - {u}_{t} ( {x}_{t} \vert {x}_{1} ) ‖}^{2} \qquad ( 1 )$$

Specifically, the conventional CFM objective (LCFM) above attempts to solve the OT problem to pair the noise samples with the data samples such that the distances (e.g., an L2 norm distance or Euclidean distance) between the noise samples and the data samples are minimized. But, due to the unique properties of 3D point clouds, the conventional CFM objective may have limitations and drawbacks.

For instance, unlike two-dimensional (2D) images, point clouds have two unique properties that pose challenges to traditional OT methods (e.g., the conventional CFM objective). First, point clouds have permutation invariance. For example, a point cloud, while arranged in a matrix form, is inherently a set. Shuffling points within the point cloud would still represent the same shape. Second, point clouds have a dense point set. For instance, point clouds are finite samples on surfaces and thus, similar to low-resolution images, sparse point sets may miss fine geometric structures and details. As such, the points within a point cloud may include a substantially large number of points (e.g., greater than 2048 points within each set).

Recently, equivariant OT flows have been developed for 3D molecules that learn permutation invariant generative models. But, using equivariant OT flows still has drawbacks due to the amount of processing that is required. For instance, the cost function of the equivariant OT flow is shown below:

$${C ( {x}_{0} , {x}_{1} ) = {min}_{g ∈ G} ‖ {x}_{0} - p ( g ) {x}_{1} ) ‖}^{2} \qquad ( 2 )$$

where p(g) is a matrix representation of the group element g. Using the equivariant OT flow approach significantly reduces the OT distance and demonstrates great success in generating molecular data. However, for 3D point clouds and in contrast to molecular data, given the second unique property described above, numerous data points are required to be used to avoid missing fine geometric structures and details. Thus, while the equivariant OT flow approach produces high-quality maps, it is computationally expensive for point cloud generation given the number of points within a point cloud (e.g., over 2048 points) whereas molecular data has a limited size (e.g., 55 points).

In particular, the cost function of the equivariant OT flow attempts to solve two problems: an inner objective and an outer objective. The outer objective may be similar to the conventional CFM objective described above, but the inner objective may be for the unique property of permutation invariance. For instance, a sampled 2D image may be represented by a matrix comprising the red, green, blue (RGB) values across the x-axis and y-axis. Even if one of the points is shuffled (e.g., RGB values for a pixel location is shuffled and now represents another pixel location), then the end result would represent a different 2D image altogether. Thus, training flow-based generative model for image generation may use solely the outer objective (e.g., assigning training data pairs to minimize the distance between noise samples and data samples). However, for molecular data and 3D point clouds, even if the points within the data samples are shuffled, the shape of the 3D point cloud would not change and would thus be permutation invariant. Therefore, in contrast to 2D images, shuffling the points within the data samples for 3D point clouds and molecular data to further minimize the distance between the points within the data samples and the noise samples may be utilized. The inner objective of the equivalent OT flow attempts to minimize the distance of the points within the data samples and the noise samples. But, due to having to compute both the inner objective and the outer objective during each training iteration, the computational complexity for the equivariant OT flow becomes too large given the quadratic number of noise and point cloud pairs in a point cloud dataset comprising a plurality of 3D point clouds (e.g., 10,000 points within a single 3D point cloud for a training object).

In other words, continuous normalizing flow (CNF) may morph a base Gaussian distribution q₀ into a data distribution q₁ using a time-variant vector field v_{θ,t}: [0,1]× [symbol] → [symbol] , parameterized by a neural network θ. The mapping may be obtained from an ODE:

$$\frac{d}{dt} {x}_{t} = {v}_{θ , t} ( {x}_{t} ) . \qquad ( 3 )$$

Conceptually, the ODE transports an initial sample x₀˜q₀, where x₀∈ [symbol] with pₜ denoting the distribution of samples at step t and p₀(x):=q₀(x). Usually, the vector field v_{θ,t} may be trained to maximize the likelihood p₁ assigned to training data samples x₁ from distribution q₁. This procedure may be computationally expensive due to extensive ODE simulation for each parameter update.

Flow matching may avoid the computationally expensive simulation process for training CNFs. In particular, a conditional vector field uₜ(·|x₁) and path pₜ(·|x₁) may be defined that transforms q₀ into a Dirac delta at x₁ at t=1. It was previously shown that v_{θ,t} may be learned via a simple CFM objective, which is shown above in Eq. (1). A common choice for the conditional vector field is uₜ(x|x₁):=x₁−x₀, which may be easily simulated by linearly interpolating the data and Gaussian samples via xₜ=(1−t)*x₀+tx₁.

OT maps are described next. In the CFM objective in Eq. (1), the training pair (x₀, x₁) may be sampled from an independent coupling: q(x₀, x₁)=q₀(x₀)q₁(x₁). However, it was shown that the training pair may be sampled from any coupling that satisfies the marginal constraint: ∫q(x₀, x₁)dx₁=q₀(x₀) and ∫q(x₀, x₁) dx₀=q₁(x₁). For instance, it was shown that an OT map π that minimizes ∫∥x₀-x₁∥²π(x₀, x₁) dx₀dx₁ may be a good choice for data coupling, leading to a straighter trajectory. Yet, obtaining the optimal transport map is often difficult for complex distributions. As such, two main conventional approaches for approximating the OT map are described below. The first is a minibatch OT approach and the second is an equivalent OT flow approach.

The minibatch OT approach approximates the actual OT by computing it at the batch level. Specifically, this approach samples a batch of Gaussian noises

$$\{ {x}_{0}^{1} , … , {x}_{0}^{B} \} \sim {q}_{0}$$

and data samples

$$\{ {x}_{1}^{1} , … , {x}_{1}^{B} \} \sim {q}_{1} ,$$

where B is the batch size. The approach solves a discrete optimal transport problem, assigning noises to data samples while minimizing a cost function C(x₀, x₁). The cost function is typically the squared-Euclidean distance, i.e., C(x₀, x₁)=∥x₀−x₁∥², and the assignment problem is often solved using the Hungarian algorithm. After computing the assignment, the assigned pairs may be used to train the vector field network via Eq. (1). As the batch size B approaches infinity, this procedure converges to sampling from the true OT map.

The equivalent OT flow matching approach also approximates the OT at the batch level, but this approach focuses on generating elements invariant to certain group G, such as permutations, rotations, and translations. Specifically, this approach proposes replacing the aforementioned cost function C(x₀, x₁) with one that accounts for these group elements (e.g., Eq. (2) above). This approach significantly reduces the OT distance even with a small batch size, demonstrating success in generating molecular data. Intuitively, using the cost function defined in Eq. (2) allows for aligning data and noise together (e.g., via permutation) when computing the minibatch OT.

So far, generic unconditional generative learning has been considered. It is worth noting that mini-batch OT does not easily extend to conditional generation problems (e.g., learning p(x|y) for a generic input conditioning y, when there is only one training sample x for each input conditioning y). This is because the OT assumes access to a batch of training samples for each y.

Next, a focus on generating 3D shapes represented as point clouds is described. For instance, a point cloud x₁∈ [symbol] is a set of points sampled from the surface of a shape [symbol] , where N is the number of points. Unlike 2D images, point clouds have unique properties such as permutation invariance and a dense point set that pose challenges for existing OT methods. For instance, for permutation invariance, a point cloud, while arranged in a matrix form, is inherently a set. Shuffling points in x₁ should represent the same shape. Mathematically, given a permutation matrix ρ(g), the sampling probability remains unchanged, i.e., q₁(ρ(g)x₁)=q₁(×1). For dense point set, point clouds are finite samples on surfaces. However, similar to low-resolution images, sparse point sets may miss fine geometric structures and details. Thus, most conventional approaches use dense point sets (e.g., N≥2048) to accurately capture 3D shapes.

Existing approaches to estimating OT maps face the below challenges on point clouds. First, the minibatch OT approach may be ineffective for point clouds. For example, the minibatch OT approach, which is effective in low-dimensional and image domains, fails for point clouds due to permutation invariance. For instance, there are N! equivalent representations of the same point cloud, implying N! equivalent training pairs (x₀, x₁). An OT-sampled pair should minimize the cost: C(x₀, x₁)=min_{g∈G}C(x₀, ρ(g)x₁). However, in minibatch OT's with no permutation, the assignments grow quadratically with batch size, while the number of permutations grows exponentially. As such, the minibatch OT approach achieves only about 6% reduction in the cost even with a batch size of 256, indicating limited effectiveness of this approach in point cloud generation.

The ineffectiveness of OT Maps in the equivariant OT approach is now discussed. The equivariant OT approach produces high-quality maps, but is computationally expensive for point cloud generation. For instance, a 48.7% reduction was achieved even with a batch size 1, showing the importance of aligning points and noise via permutation. However, unlike molecular data, which has limited size (e.g., N=55), representing 3D shapes needs a larger N, following the dense point set property described above. Solving the optimal transport cost takes an O(B²N³) computational complexity because of the quadratic number of noise and point cloud pairs in a batch of B examples, and O(N³) for the Hungarian algorithm. As such, this grows rapidly even for a typical point cloud size (N=2048) and it takes around 2.2 seconds for the OT computation even for B=1. This leads to a significant bottleneck in the training process that is more than 40 times slower than independent coupling.

Therefore, in view of the above, embodiments of the present disclosure utilize a NOS transport flow matching to pair the noise samples and the data samples. FIG. 1B shows a NOS transport flow matching process 150, in accordance with an embodiment. Each block of the process 150, described herein, may comprise a computing process that may be performed using any combination of hardware, firmware, and/or software. For instance, various functions may be carried out by a processor executing instructions stored in memory. The process 150 may also be embodied as computer-usable instructions stored on computer storage media. The process 150 may be provided by a standalone application, a service or hosted service (standalone or in combination with another hosted service), or a plug-in to another product, to name a few. In addition, the process 150 is described, by way of example, with respect to a computing system and/or platform. However, this process 150 may additionally or alternatively be executed by any one system, or any combination of systems, including, but not limited to, those described herein. Furthermore, persons of ordinary skill in the art will understand that any system that performs the process 150 is within the scope and spirit of embodiments of the present disclosure.

More illustrative information will now be set forth regarding various optional architectures and features with which the foregoing framework may be implemented, per the desires of the user. It should be strongly noted that the following information is set forth for illustrative purposes and should not be construed as limiting in any manner. Any of the following features may be optionally incorporated with or without the exclusion of other features described.

In addition, one or more computing systems or computing platforms may be used to perform one or more blocks of the process 150. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location.

At block 152, an offline pre-computation is performed to assign data pairs between sample points and data points. The offline pre-computation may be a computation performed prior to beginning training of the flow-based generative model. For instance, given that it is necessary for 3D point clouds to include dense point sets to ensure that the geometric structures and details are maintained, the NOS transport flow matching utilizes an offline pre-computation that assigns training data pairs for the sample points and data points. In particular, the training set may include a plurality of different 3D point clouds of training objects (e.g., a first, second, and third point cloud for a chair and/or a fourth, fifth, and sixth point cloud for an airplane). Each of the 3D point clouds may include a plurality of different points (e.g., a significant number of points such as over 2048 points to ensure the second unique property of point clouds), and each point may indicate a point in a 3D coordinate plane (e.g., an x, y, z coordinate).

During the offline pre-computation, noise samples and data samples may be obtained for the 3D point clouds within the training set. For instance, for each 3D point cloud within the training set, a plurality of noise samples may be obtained from a Gaussian distribution. For example, for a first 3D point cloud having 20,000 points and a second 3D point cloud having 5,000 points, 20,000 noise samples may be obtained from the Gaussian distribution for the first 3D point cloud and 5,000 noise samples may be obtained for the second 3D point cloud. Following, an offline pre-computation may be performed to map each of the 3D point cloud points to one of the noise samples to obtain offline OT maps indicating training data pairs. For example, for each 3D point cloud, an OT problem may be solved to minimize the distances (e.g., distances in the x, y, z coordinate) between the points of the 3D point cloud and the noise samples. In other words, each of the points of the 3D point cloud may be mapped to a noise sample from the noise samples such that the overall distances (e.g., trajectory) between the points of the 3D point cloud and the noise samples are minimized. An offline OT map may be obtained indicating the pairs of points and noise samples that minimize the overall distance, and an offline OT map may be obtained for each 3D point cloud within the training set. In other words, for the first 3D point cloud, a first offline OT map may be obtained that includes 20,000 entries, and each entry indicates a point from the first 3D point cloud and a corresponding noise sample from the 20,000 noise samples. Similarly, for the second 3D point cloud, a second OT map may be obtained that includes 5,000 entries indicating points from the second 3D point cloud and the corresponding noise samples.

To put it another way, in some embodiments, given supersets X₀ and X₁ where X₀ includes the noise samples and X₁ includes the points from the 3D point cloud, at block 152, a bijective map (e.g., the offline OT map) between X₀ and X₁ is computed. When the number of points M within the point cloud is small (e.g., the number of points M is below 10,000 points), the Hungarian algorithm may be used to compute the bijective map. For larger point clouds (e.g., the number of points M is above 10,000 points), a Wasserstein gradient flow may be used to transform X₀ into X₁ based on minimizing their Wasserstein distance iteratively. In experimentation, it was shown that the OT precomputation described at block 152 takes around thirty seconds for 100,000 points when using efficient graphics processing unit (GPU) implementation, which shows its high scalability.

At block 154, after obtaining the offline OT maps for the training set, random online subsampling is performed. For instance, during training of the flow-based generative model, random point samples may be obtained from the 3D point cloud. For example, from the training set, the process 150 may randomly select a 3D point cloud from the training set (e.g., a first 3D point cloud from a training set comprising a plurality of 3D point clouds of training objects), and may retrieve an offline OT map associated with the selected 3D point cloud from memory. Then, the process 150 may sample the selected 3D point cloud to obtain a plurality of data samples (e.g., 100 data samples), and each data sample may indicate a randomly selected point from the 3D point cloud. Afterwards, instead of also sampling the Gaussian distribution to obtain the noise samples, the process 150 may use the offline OT map that was obtained at block 152 to obtain the noise samples indicated by the offline OT map and the obtained data samples. For example, the offline OT map may indicate training data pairs of noise samples and points from the 3D point cloud. Based on the online sampled points from the 3D point cloud, the process 150 may determine the corresponding noise sample from the offline OT map. In other words, in contrast to the equivariant OT flow that samples both the noise distribution and the 3D point cloud during each iteration of the training, and then computes the OT that pairs each noise sample to a sampled point from the 3D point cloud, which is computationally expensive, block 154 only performs sampling of the 3D point cloud and then uses the offline OT map to determine the paired noise sample. Thus, the OT problem is not solved during each training iteration and instead, the offline OT maps are used to obtain the optimal samples.

In some examples, the offline sampling at block 152 may use a higher density or resolution 3D point cloud than the online subsampling at block 154. For example, a high resolution 3D point cloud X₁ may include 20,000 points. During the offline sampling, all 20,000 points may be mapped to a noise sample from a Gaussian noise distribution, and an offline OT map for the mapping may be obtained. During online subsampling, a subset of the points (e.g., a subset of X₁) may be selected at random as training targets. This allows convergence to the true sampling distribution due to following a straightforward extension of the law of large numbers. In other words, a subset of the points from the 3D point cloud X₁ may be selected (e.g., 5,000 out of the 20,000 total points). Then, data samples may be obtained from the subset of points (e.g., 100 data samples from the 5,000 points of the subset rather than the 20,000 points of the total 3D point cloud). Following, the offline OT map may be used to determine the 100 noise samples associated with the 100 data samples, and then the 100 noise samples and data samples may be used for training of the flow-based generative model.

In other words, referring to blocks 152 and 154, a simple approach to generate training point clouds is to re-sample the points from the object surface in each training iteration. However, most point cloud generation methods avoid this tedious online sampling by pre-sampling a dense point superset X₁∈ [symbol] with M»N. During training, random subsets of X₁ are selected as training targets. This procedure converges to the true sampling distribution, following a straightforward extension of the law of large numbers. In a similar spirit, embodiments of the present disclosure compute an offline OT map between a dense point superset X₁∈ [symbol] and a dense randomly-sampled Gaussian noise superset X₀∈ [symbol] , and during training, subsample data-noise pairs from the supersets based on the offline OT map.

The superset OT precomputation is now described (e.g., block 152). Given supersets X₀ and X₁, embodiments of the present disclosure compute a bijective map Π between them, i.e., Π: X₀↔X₁. When M is small, embodiments of the present disclosure compute the bijective map using the Hungarian algorithm. However, this algorithm may scale poorly for large point clouds, e.g., M>10K. For such large point clouds, embodiments of the present disclosure use Wasserstein gradient flow to transform X₀ into X₁ by minimizing their Wasserstein distance iteratively.

Online random subsampling is now described (e.g., block 154). Given precomputed coupling Π(X₀, X₁), embodiments of the present disclosure randomly sample data-noise pair (x₀, x₁)˜Π(X₀, X₁) and embodiments of the present disclosure train the flow matching model according to Eq. (1). It was shown that this may significantly reduce the transport cost, while introducing negligible training overhead. Further, it was shown that the sampled training pair converges to correct marginals if M is sufficiently large.

In some examples, using these pairs for training results in straighter sampling trajectories, measured by the curvature of the sampling trajectory. The model trained based on the above OT approximation exhibits a much lower maximum curvature compared to the one with independent coupling.

In some instances, by skipping block 156 and moving directly to block 158, the subsampled data pairs (e.g., the 100 noise samples and the 100 data samples) may be used to train the flow-based generative model. For instance, the flow-based generative model may be trained based on the CFM objective (LCFM) described above. The performance of training the flow-based generative model based on skipping block 156 is shown in graphical representation 104 of FIG. 1B. However, it was shown that flow-based generative models that were trained using only the OT maps were outperformed by flow-based generative models that were trained using independent coupling, especially when the number of sampling steps were large. This may be caused due to the increasing complexity of target vector fields for OT couplings that makes their approximation harder with neural networks.

As such, block 156 and hybrid coupling is used, which is shown by graphical representation 106 of FIG. 1A. For example, block 156 includes adding noise (e.g., noise ϵ) to the noise samples from the random online sampling. For instance, given the different behavior of independent and OT couplings, embodiments of the present disclosure may aim to reduce the complexity of the vector field at early time steps by combining the OT approximations with independent coupling. Specifically, block 156 may use the below expression to obtain the noise samples x′₀ that are used for training at block 158:

$$\begin{matrix}{x}_{0}^{′} = \sqrt{1 - β} {x}_{0} + \sqrt{β} ϵ , & ϵ \sim 𝒩\end{matrix} ( ϵ ; 0 , I ) \qquad ( 4 )$$

where x₀ are the noise samples that were obtained using the offline OT maps and the random data samples obtained from the 3D point cloud at block 154, β is a blending coefficient that blends between the OT couplings and the independent couplings, and ϵ is the noise added based on sampling from a Gaussian distribution. In other words, β represents a blending coefficient that is used to switch between independent coupling (e.g., when β is equal to 1) and OT coupling (e.g., when β is equal to 0). Thus, at block 156, β is obtained (e.g., from user input) and then used in the above expression to determine the noise samples (e.g., modified noise samples) that are then used at block 158 to train the flow-based generative models. For example, based on β being equal to 0.1 or 0.2, the noise samples x, that were obtained at block 154 (e.g., using the offline OT maps and the random data samples obtained from the 3D point cloud) are perturbed by a small amount (e.g., a value of β at 0.1 or 0.2) of Gaussian noise. Then, the modified noise samples x′₀ are used at block 158 to perform training of the flow-based generative models. In other words, \sqrt{1−βx₀} may represent the weighted noise samples and \sqrt{βϵ} may represent the noise to be added to the noise samples obtained at block 154. The addition of the weighted noise sample sand the noise to be added may indicate the modified noise samples.

In other words, at block 154, random online subsampling may be performed to obtain a plurality of sets of data samples associated with a training set comprising a plurality of 3D point clouds of objects. Each set of data samples may include a plurality of data samples indicating points from a 3D point cloud from the training set. For example, each set of data samples may comprise 100 data points indicating x, y, z coordinates of points from the 3D point cloud, and the process 150 may obtain multiple different sets (e.g., ten sets of 100 data samples). The different sets may be from the same 3D point cloud from the training set or from different 3D point clouds from the training set. Afterwards, using the offline OT maps obtained from block 152 (e.g., retrieving an offline OT map stored in memory), the process 150 may determine noise samples associated with each data sample from each set of data samples (e.g., 1,000 noise samples that are associated with the ten sets of 100 data samples). Following, at block 156, the process 150 may add noise to each of the noise samples (e.g., each of the 1,000 noise samples) based on the above expression (e.g., determine the modified noise samples x′₀ based on the blending coefficient β and the noise samples from the offline OT maps).

To put it another way and referring to block 156, though training flows with OT couplings come with appealing theoretical justifications (e.g., straight sampling trajectories), through experiments, it was identified that flows trained with equivariant OT maps are often outperformed by those with independent coupling in terms of sample quality, especially when the number of sampling steps is large. This was hypothesized due to the increasing complexity of target vector fields for OT couplings that makes their approximation harder with neural networks.

Intuitively, as target sampling trajectories are made straighter using more accurate OT couplings, the complexity of generation shifts toward smaller time steps. In the limit of straight trajectories, the learned vector field v_{θ,0}(x₀) should be able to switch between different target point clouds with small variation in x₀, forcing v_{θ,0} to be complex at t=0. This problem is further exacerbated in the equivariant OT flows with large N where permuting Gaussian noise cloud in the input makes it virtually the same for all target point clouds. To verify this, the trained vector field's complexity for 3D point cloud generation using the Jacobian Frobenius norm in different timesteps was measured. As hypothesized above, switching from independent coupling to the OT approximation described above shifts the high Jacobian norm at t≈1 for independent coupling to t≈0 for OT coupling. This motivated a development to make it easier for neural networks to approximate the target vector field, while still maintaining a relatively straight path.

As such, embodiments of the present disclosure utilize hybrid coupling (e.g., block 156). Given the different behavior of independent and OT couplings, embodiments of the present disclosure aim to reduce the complexity of the vector field at early timesteps by combining the OT approximation with independent coupling. To do so, embodiments of the present disclosure inject additional random Gaussian noise into x₀, making the OT couplings even less “optimal.” The new training

$${x}_{0}^{′}$$

is defined by Eq. (4) above, and the blending coefficient may be β∈[0,1]. Intuitively β allows for switching smoothly between independent and OT couplings. Specifically, for β→0, the coupled data and noise pairs converge to the OT couplings, whereas when β→1, they follow the independent coupling.

In some embodiments, a β=0.2 may be used, which may strike a good balance between learning complexity, low curvature for the sampling trajectories, and sample generation quality.

Subsequently, at block 158, the process 150 may use the data pairs (e.g., the 1,000 modified noise samples and the ten sets of 100 data samples) to train the generative flow-based model. For instance, the process 150 may use the CFM objective along with the modified noise samples and the data samples to train the generative flow-based model. For training, blocks 154-158 may repeat one or more iterations (e.g., new data samples and modified noise samples may be obtained) to generate x₀ and x₁ couplings for the CFM objective. For every pair of x₀ and x₁, a random time variable t∈[0,1] may be sampled from uniform distribution and xₜ=(1−t)x₀+txₜ may be constructed by linearly combining x₀ and x₁. Then, xₜ may be fed to the flow model v_{θ,t}(xₜ) and the flow model may be trained to predict uₜ(xₜ|x₁):=x₁−x₀ based on minimizing the L2 loss in the CFM objective. This iterative process of obtaining x₀ and x₁ pairs and training the flow model may be repeated until a convergence criterion or a maximum number of iterations is met.

After training the generative flow-based model, the generative flow-based model may be used to generate 3D point clouds of objects during inference. For instance, based on a prompt (e.g., user prompt), the generative flow-based model may generate a 3D point cloud that is responsive to the prompt.

Among other benefits and advantages, embodiments of the present disclosure provide process 150 to perform offline pre-computation to generate offline OT maps that are used during online training of the generative flow-based model. Additionally, and/or alternatively, the process 150 may further include randomly subsampling from only the training set of the 3D point clouds, and obtaining the training data pairs of the noise samples and data samples based on the random subsampling the offline OT maps. Additionally, and/or alternatively, the process 150 also may use a hybrid coupling that includes adding a slight perturbation of noise to the noise samples obtained by the offline OT maps, and using the modified noise samples for training of the generative flow-based model.

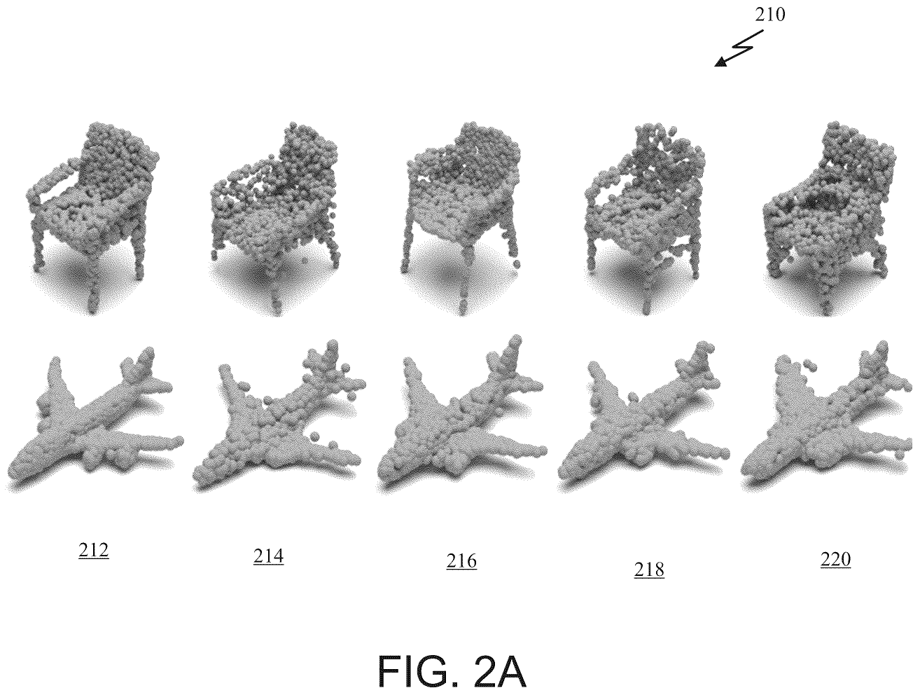

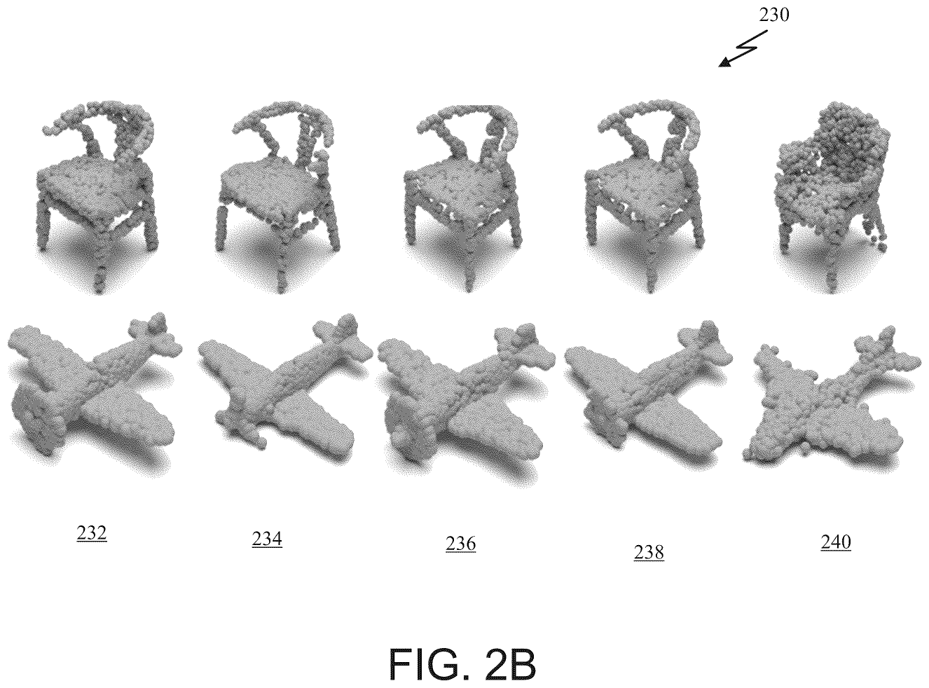

FIGS. 2A and 2B show examples 210 and 230 of point clouds 212-220 and 232-240 that are generated using different approaches. For example, both FIGS. 2A and 2B show qualitative comparisons of generation qualities for chairs (top row of FIGS. 2A and 2B) and airplanes (bottom row of FIGS. 2A and 2B) using different approaches. Specifically, FIG. 2A shows point clouds 212-220 that were generated using different approaches with 10 inference steps and FIG. 2B shows point clouds 232-240 that were generated using different approaches with 100 inference steps.

Referring to FIG. 2A, the point clouds 212 (e.g., the chair and the airplane) were generated based on using the NOS transport flow matching process 150 described above. The point clouds 214 were generated based on using a diffusion model. The point clouds 216 were generated based on using independent coupling. The point clouds 218 were generated based on using the minibatch OT approach. The point clouds 220 were generated based on using the equivariant OT approach.

Referring to FIG. 2B, the point clouds 232 (e.g., the chair and the airplane) were generated based on using the NOS transport flow matching process 150 described above. The point clouds 234 were generated based on using a diffusion model. The point clouds 236 were generated based on using independent coupling. The point clouds 238 were generated based on using the minibatch OT approach. The point clouds 240 were generated based on using the equivariant OT approach.

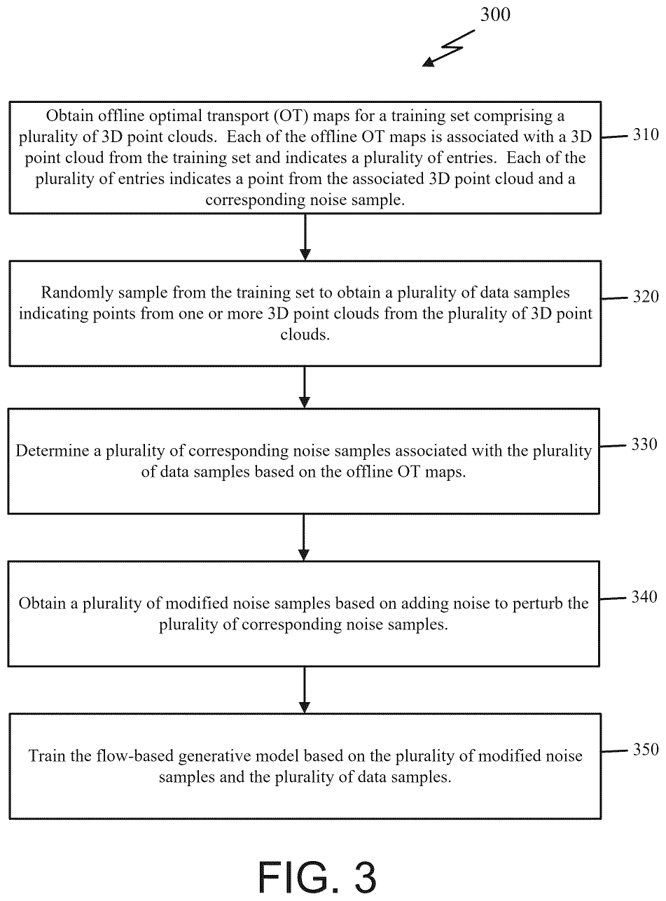

FIG. 3 provides a flow diagram illustrating a method 300 for training a flow-based generative model for 3D point cloud generation, in accordance with an embodiment. Each block of method 300, described herein, comprises a computing process that may be performed using any combination of hardware, firmware, and/or software. For instance, various functions may be carried out by a processor executing instructions stored in memory. The method 300 may also be embodied as computer-usable instructions stored on computer storage media. The method 300 may be provided by a standalone application, a service or hosted service (standalone or in combination with another hosted service), or a plug-in to another product, to name a few. In addition, method 300 is described, by way of example, with respect to the process 150. However, the method 300 may additionally or alternatively be executed by any one system, or any combination of systems, including, but not limited to, those described herein. Furthermore, persons of ordinary skill in the art will understand that any system that performs method 300 is within the scope and spirit of embodiments of the present disclosure.

At step 310, offline OT maps for a training set comprising a plurality of 3D point clouds may be obtained. Each of the offline OT maps is associated with a 3D point cloud from the training set and indicates a plurality of entries. Each of the plurality of entries indicates a point from the associated 3D point cloud and a corresponding noise sample. In an embodiment, obtaining the offline OT maps comprises: for a first 3D point cloud from the training set, sampling a Gaussian distribution to obtain a plurality of offline noise samples; and generating a first offline OT map for the first 3D point cloud, wherein the first offline OT map comprises a plurality of entries. Each of the plurality of entries indicates an offline noise sample from the plurality of offline noise samples and a point from the first 3D point cloud. In an embodiment, generating the first offline OT map comprises: assigning each point from the first 3D point cloud to an offline noise sample from the plurality of offline noise samples based on minimizing an overall distance between the points from the first 3D point cloud and the plurality of offline noise samples; and generating the first offline OT map comprising the plurality of entries based on the assigning. In an embodiment, a number of the plurality of offline noise samples is the same as a number of the points from the first 3D point cloud.

At step 320, a plurality of data samples indicating points from one or more 3D point clouds from the plurality of 3D point clouds may be obtained by randomly sampling from the training set.

At step 330, a plurality of corresponding noise samples associated with the plurality of data samples may be determined based on the offline OT maps. In an embodiment, the plurality of data samples are associated with a first 3D point cloud from the plurality of 3D point clouds and determining the plurality of corresponding noise samples comprises: retrieving an offline OT map associated with the first 3D point cloud from memory that stores the offline OT maps for the training set; and determining the plurality of corresponding noise samples for each of the plurality of data samples based on the retrieved offline OT map.

At step 340, a plurality of modified noise samples may be obtained based on adding noise to perturb the plurality of corresponding noise samples. In an embodiment, obtaining the plurality of modified noise samples comprises: determining the noise to add to the plurality of corresponding noise samples based on a blending coefficient; and obtaining the plurality of modified noise samples by adding the noise to each of the plurality of corresponding noise samples. In an embodiment, determining the noise to add comprises: multiplying a square root of the blending coefficient with sampled noise from a Gaussian distribution to determine the noise. In an embodiment, obtaining the plurality of modified noise samples by adding the noise to each of the plurality of corresponding noise samples comprises: determining a plurality of weighted corresponding noise samples based on the blending coefficient; and obtaining the plurality of modified noise samples based on adding the determined noise to the plurality of weighted corresponding noise samples.

At step 350, the flow-based generative model may be trained based on the plurality of modified noise samples and the plurality of data samples.

In an embodiment, the method 300 may further include subsequent to training the flow-based generative model, using the flow-based generative model to generate one or more 3D point clouds.

In an embodiment, at least one of steps 310-350 and/or the further steps described above for method 300 are performed on a server or in a data center to generate a 3D point cloud, and the 3D point cloud is streamed to a user device. In an embodiment, at least one of steps 310-350 and/or the further steps described above for method 300 is performed within a cloud computing environment. In an embodiment, at least one of steps 310-350 and/or the further steps described above for method 300 is performed for training, testing, or certifying a neural network employed in a machine, robot, or autonomous vehicle. In an embodiment, at least one of steps 310-350 and/or the further steps described above for method 300 is performed on a virtual machine comprising a portion of a graphics processing unit.

In some examples, embodiments of the present disclosure describe a simple and scalable generative model for 3D point cloud generation using flow matching (e.g., NOS transport flow matching). For example, embodiments of the present disclosure may first utilize an efficient method to obtain an approximate optimal transport (OT) between point cloud and noise samples. Instead of searching for an optimal permutation between the point cloud and noise samples online during training, which is computationally expensive, embodiments of the present disclosure precompute OTs between a dense point superset and a dense noise superset offline. Furthermore, embodiments of the present disclosure utilize a simple approach to construct a less “optimal” hybrid coupling by blending the approximate OT and independent coupling used in the flow matching model. In particular, embodiments of the present disclosure may perturb the noise samples obtained from the approximate OT with small Gaussian noise. While this remedy makes the mapping less optimal from the OT perspective, it was empirically shown to have two main advantages. First, the target flow model is less complex and the generated points clouds have high sample quality. Second, when reducing the number of inference steps, the generation quality still degrades slower than other competing techniques, indicating smoother trajectories.

### EXEMPLARY COMPUTING SYSTEM

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

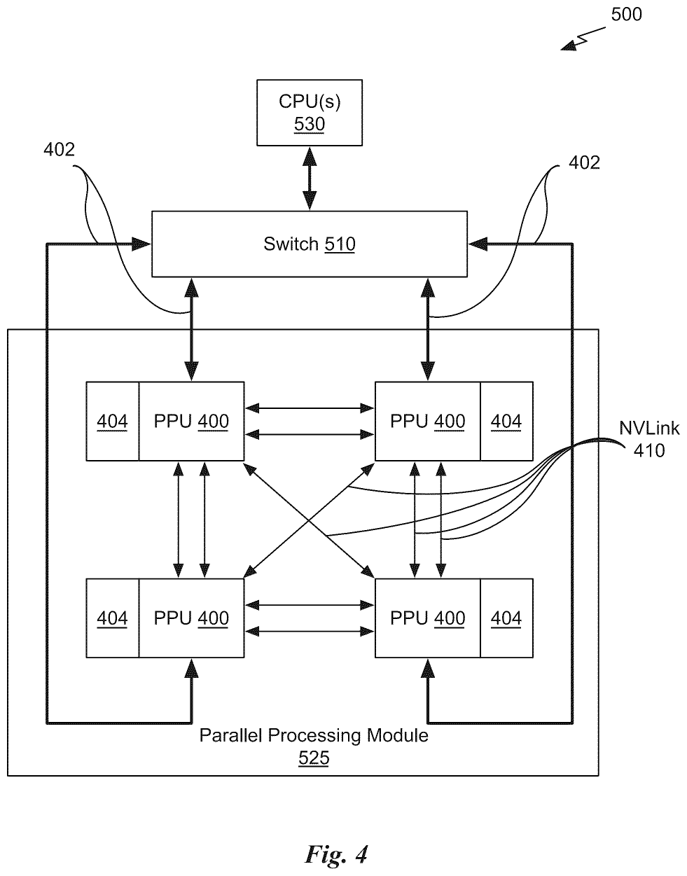

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

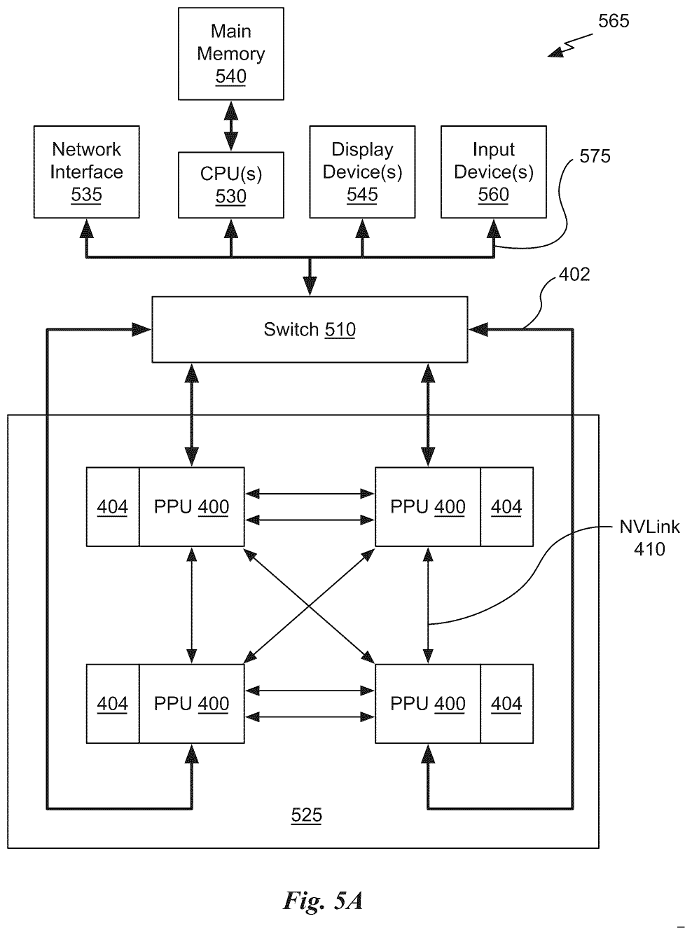

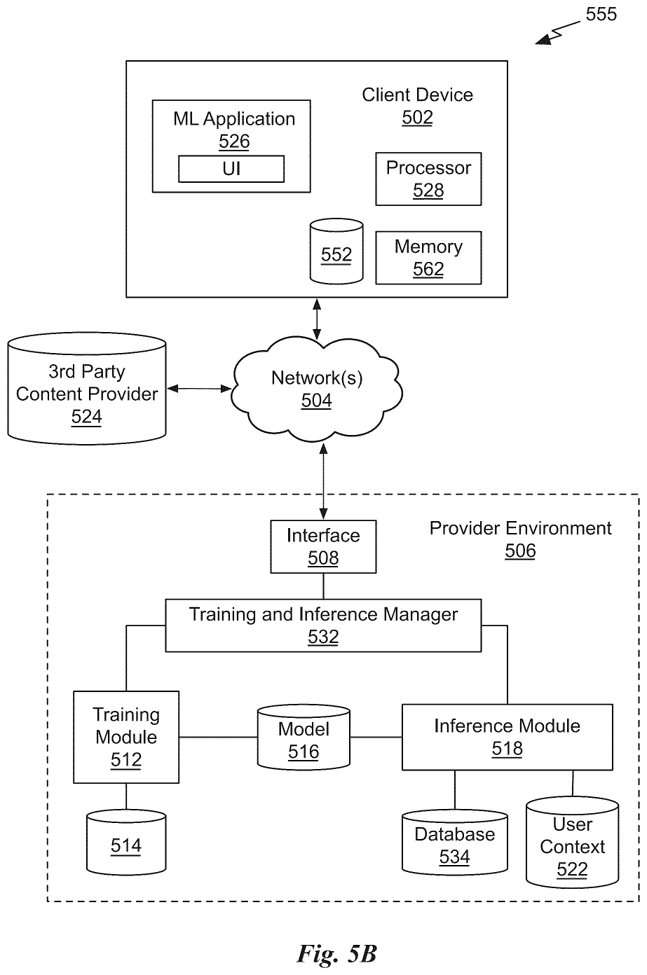

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### EXAMPLE NETWORK ENVIRONMENTS

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting. Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### EXAMPLE STREAMING SYSTEM

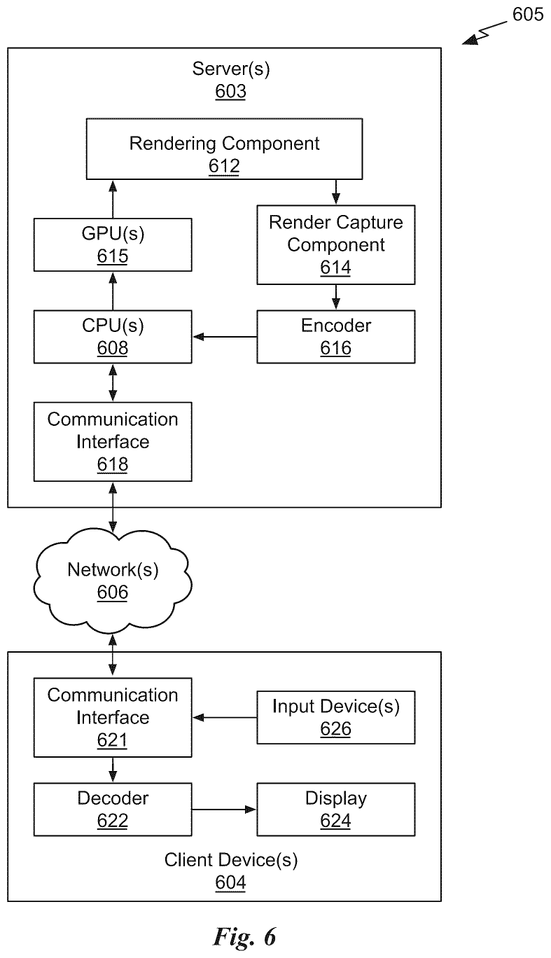

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques—of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A computer-implemented method for training a flow-based generative model for three-dimensional (3D) point cloud generation, comprising:
obtaining offline optimal transport (OT) maps for a training set comprising a plurality of 3D point clouds, wherein each of the offline OT maps is associated with a 3D point cloud from the training set and indicates a plurality of entries, wherein each of the plurality of entries indicates a point from the associated 3D point cloud and a corresponding noise sample;
randomly sampling from the training set to obtain a plurality of data samples indicating points from one or more 3D point clouds from the plurality of 3D point clouds;
determining a plurality of corresponding noise samples associated with the plurality of data samples based on the offline OT maps;
obtaining a plurality of modified noise samples based on adding noise to perturb the plurality of corresponding noise samples; and
training the flow-based generative model based on the plurality of modified noise samples and the plurality of data samples.

2. The computer-implemented method of claim 1, further comprising:
subsequent to training the flow-based generative model, using the flow-based generative model to generate one or more 3D point clouds.

3. The computer-implemented method of claim 1, wherein obtaining the offline OT maps comprises:
for a first 3D point cloud from the training set, sampling a Gaussian distribution to obtain a plurality of offline noise samples; and
generating a first offline OT map for the first 3D point cloud, wherein the first offline OT map comprises a plurality of entries, and wherein each of the plurality of entries indicates an offline noise sample from the plurality of offline noise samples and a point from the first 3D point cloud.

4. The computer-implemented method of claim 3, wherein generating the first offline OT map comprises:
assigning each point from the first 3D point cloud to an offline noise sample from the plurality of offline noise samples based on minimizing an overall distance between the points from the first 3D point cloud and the plurality of offline noise samples; and
generating the first offline OT map comprising the plurality of entries based on the assigning.

5. The computer-implemented method of claim 3, wherein a number of the plurality of offline noise samples is the same as a number of the points from the first 3D point cloud.

6. The computer-implemented method of claim 1, wherein the plurality of data samples are associated with a first 3D point cloud from the plurality of 3D point clouds, and wherein determining the plurality of corresponding noise samples comprises:
retrieving an offline OT map associated with the first 3D point cloud from memory that stores the offline OT maps for the training set; and
determining the plurality of corresponding noise samples for each of the plurality of data samples based on the retrieved offline OT map.

7. The computer-implemented method of claim 1, wherein obtaining the plurality of modified noise samples comprises:
determining the noise to add to the plurality of corresponding noise samples based on a blending coefficient; and
obtaining the plurality of modified noise samples by adding the noise to each of the plurality of corresponding noise samples.

8. The computer-implemented method of claim 7, wherein determining the noise to add comprises:
multiplying a square root of the blending coefficient with sampled noise from a Gaussian distribution to determine the noise.

9. The computer-implemented method of claim 8, wherein obtaining the plurality of modified noise samples by adding the noise to each of the plurality of corresponding noise samples comprises:
determining a plurality of weighted corresponding noise samples based on the blending coefficient; and
obtaining the plurality of modified noise samples based on adding the determined noise to the plurality of weighted corresponding noise samples.

10. The computer-implemented method of claim 1, wherein at least one of the steps of obtaining, randomly sampling, determining, and training are performed on a server or in a data center to generate a 3D point cloud, and the 3D point cloud is streamed to a user device.

11. The computer-implemented method of claim 1, wherein at least one of the steps of obtaining, randomly sampling, determining, and training are performed within a cloud computing environment.

12. The computer-implemented method of claim 1, wherein at least one of the steps of obtaining, randomly sampling, determining, and training are performed for training, testing, or certifying a neural network employed in a machine, robot, or autonomous vehicle.

13. The computer-implemented method of claim 1, wherein at least one of the steps of obtaining, randomly sampling, determining, and training are performed on a virtual machine comprising a portion of a graphics processing unit.

14. A system for performing a truncated consistency model training framework, comprising:
one or more processors; and
a non-transitory computer-readable medium having processor-executable instructions stored thereon, wherein the processor-executable instructions, when executed by the one or more processors, facilitate:
obtaining offline optimal transport (OT) maps for a training set comprising a plurality of 3D point clouds, wherein each of the offline OT maps is associated with a 3D point cloud from the training set and indicates a plurality of entries, wherein each of the plurality of entries indicates a point from the associated 3D point cloud and a corresponding noise sample;
randomly sampling from the training set to obtain a plurality of data samples indicating points from one or more 3D point clouds from the plurality of 3D point clouds;
determining a plurality of corresponding noise samples associated with the plurality of data samples based on the offline OT maps;
obtaining a plurality of modified noise samples based on adding noise to perturb the plurality of corresponding noise samples; and
training the flow-based generative model based on the plurality of modified noise samples and the plurality of data samples.

15. The system of claim 14, wherein the processor-executable instructions, when executed by the one or more processors, further facilitate:
subsequent to training the flow-based generative model, using the flow-based generative model to generate one or more 3D point clouds.

16. The system of claim 14, wherein obtaining the offline OT maps comprises:
for a first 3D point cloud from the training set, sampling a Gaussian distribution to obtain a plurality of offline noise samples; and
generating a first offline OT map for the first 3D point cloud, wherein the first offline OT map comprises a plurality of entries, and wherein each of the plurality of entries indicates an offline noise sample from the plurality of offline noise samples and a point from the first 3D point cloud.

17. The system of claim 16, wherein generating the first offline OT map comprises:
assigning each point from the first 3D point cloud to an offline noise sample from the plurality of offline noise samples based on minimizing an overall distance between the points from the first 3D point cloud and the plurality of offline noise samples; and
generating the first offline OT map comprising the plurality of entries based on the assigning.

18. The system of claim 14, wherein the plurality of data samples are associated with a first 3D point cloud from the plurality of 3D point clouds, and wherein determining the plurality of corresponding noise samples comprises:
retrieving an offline OT map associated with the first 3D point cloud from memory that stores the offline OT maps for the training set; and
determining the plurality of corresponding noise samples for each of the plurality of data samples based on the retrieved offline OT map.

19. A non-transitory computer-readable medium having processor-executable instructions stored thereon for performing a truncated consistency model training framework, wherein the processor-executable instructions, when executed, facilitate:
obtaining offline optimal transport (OT) maps for a training set comprising a plurality of 3D point clouds, wherein each of the offline OT maps is associated with a 3D point cloud from the training set and indicates a plurality of entries, wherein each of the plurality of entries indicates a point from the associated 3D point cloud and a corresponding noise sample;
randomly sampling from the training set to obtain a plurality of data samples indicating points from one or more 3D point clouds from the plurality of 3D point clouds;
determining a plurality of corresponding noise samples associated with the plurality of data samples based on the offline OT maps;
obtaining a plurality of modified noise samples based on adding noise to perturb the plurality of corresponding noise samples; and
training the flow-based generative model based on the plurality of modified noise samples and the plurality of data samples.

20. The non-transitory computer-readable medium of claim 19, wherein the processor-executable instructions, when executed, further facilitate:
subsequent to training the flow-based generative model, using the flow-based generative model to generate one or more 3D point clouds.
